(19) United States
(12) Patent Application Publication
(10) Pub. No.: US 2012/0081235 A1
(43) Pub. Date: Apr. 5, 2012

(54) Power Control in Wireless Traffic Detection Devices

(75) Inventors: Tamer M. Nadeem, Virginia Beach, VA (US); Nazif Cihan Tas, Lawrenceville, NJ (US)

(73) Assignee: Siemens Corporation, Iselin, NJ (US)

(21) Appl. No.: 13/232,248

(22) Filed: Sep. 14, 2011

Related U.S. Application Data
(60) Provisional application No. 61/388,014, filed on Sep. 30, 2010.
(60) Provisional application No. 61/388,012, filed on Sep. 30, 2010.

(51) Int. Cl. G08G 1/01

(52) U.S. Cl. 340/933

(57) ABSTRACT

Methods, systems, and devices for monitoring roadway traffic. A method includes transmitting wireless signals from a first roadside equipment (RSE) device and from a second RSE device that is geographically separated from the first RSE device. The method includes receiving responses by the first RSE device and second RSE device from a wireless device. The responses include a unique identifier corresponding to the wireless device. The method includes transmitting data from the first RSE device and the second RSE device to a control system, where the data includes the unique identifier and times that the responses were received. The method includes receiving a power control command, based on the transmitted data, from the control system, and adjusting a transmit power of the wireless signals transmitted by the first RSE device based on the power control command.

### CROSS-REFERENCE TO OTHER APPLICATION

This application claims the benefit of the filing date of U.S. Provisional Patent Applications 61/388,014, filed Sep. 30, 2010, and 61/388,012, filed Sep. 30, 2010, which are hereby incorporated by reference. This application has some subject matter in common with commonly-assigned, concurrently-filed U.S. patent application Ser. No. ______ for “Data Collection and Traffic Control Using Multiple Wireless Receivers”, hereby incorporated by reference.

### TECHNICAL FIELD

The present disclosure is directed, in general, to improved traffic monitoring and control systems and methods.

### BACKGROUND OF THE DISCLOSURE

For reasons related to safety, efficiency, environmental concerns, and other issues, improved traffic control and monitoring systems are desirable.

### SUMMARY OF THE DISCLOSURE

Various disclosed embodiments include methods, systems, and devices for monitoring roadway traffic. A method includes transmitting wireless signals from a first roadside equipment (RSE) device and from a second RSE device that is geographically separated from the first RSE device. The method includes receiving responses by the first RSE device and second RSE device from a wireless device. The responses include a unique identifier corresponding to the wireless device. The method includes transmitting data from the first RSE device and the second RSE device to a control system, where the data includes the unique identifier and times that the responses were received. The method includes receiving a power control command, based on the transmitted data, from the control system, and adjusting a transmit power of the wireless signals transmitted by the first RSE device based on the power control command.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 depicts a simplified block diagram of an onboard equipment system in accordance with disclosed embodiments;

FIG. 2 depicts a simplified block diagram of a roadside equipment device in accordance with disclosed embodiments;

FIG. 3 depicts an example of an implementation on two intersections, in accordance with disclosed embodiments; and

FIG. 4 depicts a process in accordance with disclosed embodiments.

### DETAILED DESCRIPTION

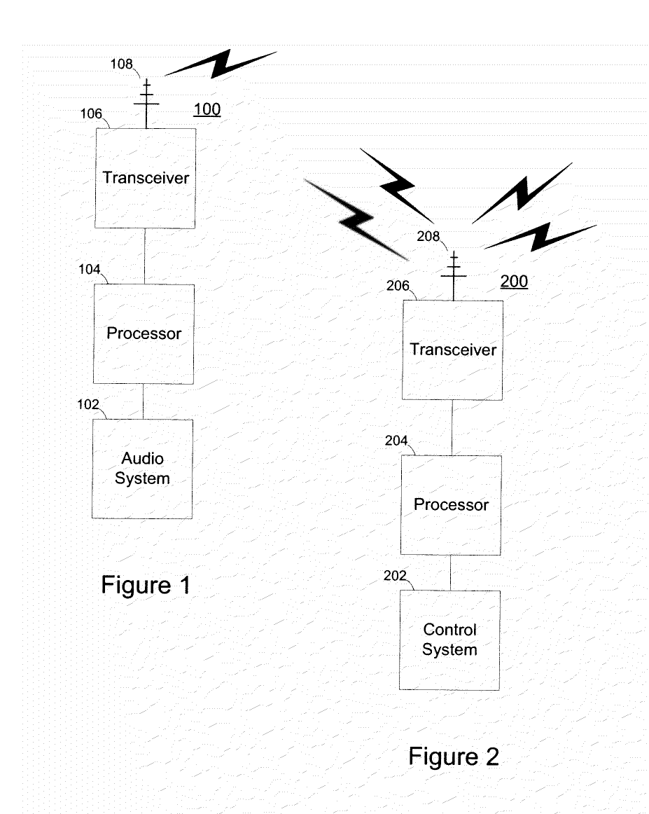

FIGS. 1 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

Efficient traffic management can be accomplished using intelligent traffic control systems that are able to detect vehicles in the area of a traffic control device. Disclosed embodiments include systems and methods in which individual vehicles broadcast information to be received and processed by the traffic control system, which can use the information to determine such information as the speed and direction of travel of the vehicle.

As described herein and in the patent application referenced above and incorporated herein, the systems and methods disclosed herein include various means of using onboard equipment (OBE) installed or used in a vehicle and roadside equipment (RSE) that detects the vehicle by communicating with the OBE. Of course, in various embodiments, some or all of the components of the RSE could be physically located other than “roadside”, such as in a cabinet, traffic controller, signal head, or otherwise. The RSE can be used to control many different types of traffic equipment, and can be used to collect and send data to a central monitoring station for further analysis or action, using common networking and communication techniques.

For the OBE and RSE, radio technology can be used, and in particular, Bluetooth® wireless technology as described by the BLUETOOTH SPECIFICATION Version 4.0 (Jun. 30, 2010) by Bluetooth SIG, Inc., hereby incorporated by reference, can be used to implement techniques as described herein. Devices and processes that conform to this specification will be referred to herein as “Bluetooth®-compliant”.

Disclosed embodiments include an RSE system and method that enables efficient identification of vehicles and their travel by adjusting the power of the RSE to reduce redundancy and error.

FIG. 1 depicts a simplified block diagram of an onboard equipment (OBE) system 100 in accordance with disclosed embodiments. In this diagram, processor 104 is connected between audio system 102 and transceiver 106, such that the processor 104 processes audio signals to and from audio system 102, and can transmit corresponding signals using transceiver 106 and antenna 108. In particular, processor 104, transceiver 106, and antenna 108 can be implemented using a Bluetooth®-compliant device, such as a user earpiece, mobile terminal such as a mobile phone or smartphone, and in particular can be implemented as part of an automobile's electronics, where the audio system 102 can be the automobile audio system. OBE system 100, in various embodiments, can perform one or more Bluetooth®-compliant processes or operations as described herein.

Those of skill in the art will recognize that not all other details are shown in this simplified diagram. For example, audio system 102 can be the audio system of an earpiece, mobile telephone, or computer system, or may also be connected to an automobile navigation system, an emergency-communication system, or to other components of an automobile. The audio system 102, processor 104, and transceiver 106 will each also be connected to a power source, such as a vehicle power source, and may each be connected to other systems and components of a vehicle. The processor 104, and other components, can be connected to read and write to a storage such as volatile and non-volatile memory, magnetic, optical, or solid-state media, or other storage devices. The antenna 108 may be dedicated to transceiver 106, or may be connected to be shared with other components. Processor 104 may be configured to perform only the processes described herein, or can also be configured to perform other processes for the operation and management of the vehicle. The various components of FIG. 1 could be constructed as separate elements connected to communicate with each other, or two or more of these components could be integrated into a single device. In some embodiments, the “audio system” 102 is not necessarily or exclusively an audio system, but can be another Bluetooth®-compliant device such as a computer, mobile telephone, or otherwise, and can perform other functions such as file transfers and otherwise.

FIG. 2 depicts a simplified block diagram of a roadside equipment (RSE) device 200, in accordance with disclosed embodiments, that can be configured to perform processes as described herein. In this diagram, processor 204 is connected between a control system 202 and a transceiver 206. In particular, processor 204, transceiver 206, and antenna 208 can be implemented as a Bluetooth®-compliant device, and can perform one or more Bluetooth®-compliant processes or operations as described herein. The RSE device is an example of means for detecting wireless devices, such as Bluetooth®-compliant receivers or other OBE devices, traveling on a roadway. In some cases, an RSE can have multiple antennas that can be co-located, separated, oriented, or otherwise arranged to provide suitable transmission and reception for the location of the RSE.

The transceiver 206 sends data to and receives data from the OBE system 100 and then communicates it to the processor 204. The processor 204 can then communicate with the control system 202, which can use it for traffic control, monitoring, and management processes, as described in more detail herein. Control system 202 can be a signal controller, a traffic signal with integrated controller, or other system configured to control traffic equipment, and in particular can be a centralized server system. In various embodiments, control system 202 can be connected to and can communicate with multiple RSE systems 200, each of which include a processor 204, transceiver 206, and antenna 208. Processor 204 can adjust the transmission power of transceiver 206, as described herein, either under its own control or under the control of control system 202.

Those of skill in the art will recognize that not all other details are shown in this simplified diagram. For example, control system 202, processor 204, and transceiver 206 will each also be connected to a power source, and may each be connected to other systems and components of the RSE. The processor 204, and other components, can be connected to read and write to a storage such as volatile and non-volatile memory, magnetic, optical, or solid-state media, or other storage devices. The antenna 208 may be dedicated to transceiver 206, or may be connected to be shared with other components. Processor 204 may be configured to perform only the processes described herein, or can also be configured to perform other processes for the operation and management of the RSE. The various components of FIG. 2 could be constructed as separate elements connected to communicate with each other, or two or more of these components could be integrated into a single device. In particular, processor 204 can be an integral part of the control system 202, and perform many or all of the other functions of the RSE.

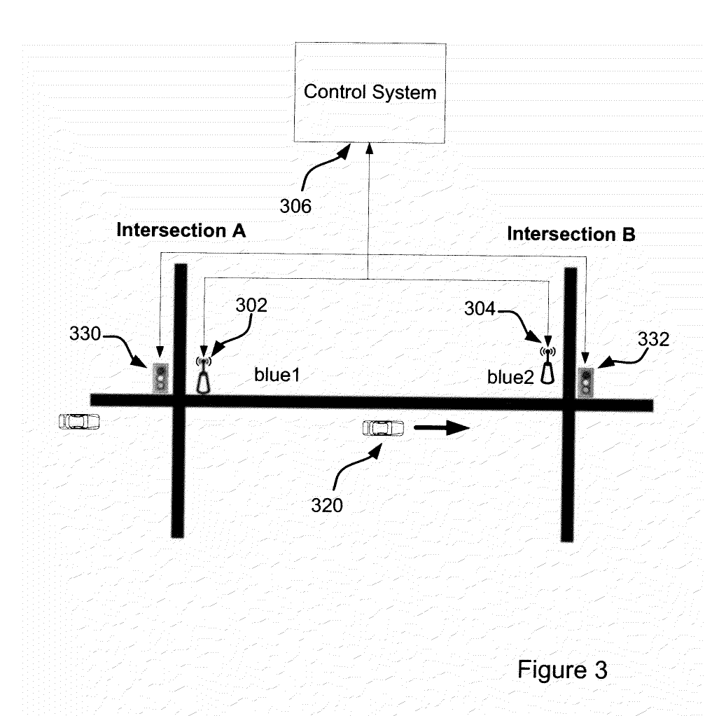

Disclosed embodiments have particular use in traffic control and monitoring systems. FIG. 3 depicts an example of an implementation on two intersections, in accordance with disclosed embodiments. Traffic Light Control (TLC) makes traffic data collection an important component of traffic management, and disclosed embodiments provide novel and effective means for accurate traffic data collection. One approach for data collection using Bluetooth® interfaces at traffic intersections in order to estimate the average travel time for the vehicles is disclosed in U.S. Patent Publication 2010/0302070A1 to Puckett, et al., hereby incorporated by reference.

In the example of FIG. 3, a car 320 first appears at Intersection A and travels toward Intersection B. It is assumed that car 320 has on-board equipment such as OBE 100, which can be a Bluetooth®-compliant device. Each intersection has roadside equipment such as RSE 200, shown as blue1 302 and blue2 304, which can be Bluetooth®-compliant devices. Blue1 302 and blue2 304 are connected to communicate with control system 306. Control system 306 can also be connected to control traffic signals 330 and 332 at the respective intersections. In some embodiments, the RSE can be integrated with the traffic signals; for example, RSE blue1 302 can be integrated with traffic signal 330.

The on-board equipment such as OBE 100 in car 320 has a unique identifier; optionally, each RSE 200, including blue1 302 and blue2 304, also has a unique identifier. In a Bluetooth® implementation, the unique identifier can be a Bluetooth Device Address (BD_ADDR), which is a 48-bit address used to identify each Bluetooth® device. The OBE is a connectable device in range that periodically listens on its page scan physical channel and will respond to a page on that channel or a device that is advertising using a connectable advertising event. Alternately or additionally, the OBE is a device that listens for and responds to inquiry messages received on its inquiry scan physical channel.

Each RSE 200 including blue1 302 and blue2 304 can perform a “paging” operation where it transmits a train of page messages until a response is received from the target OBE device or a timeout occurs. Each RSE 200 can act, in various embodiments, as a paging device. Alternately or additionally, each RSE 200 including blue1 302 and blue2 304 can perform an “inquiry” procedure where it transmits inquiry messages and listens for responses in order to discover the other Bluetooth devices that are within its respective coverage area; each RSE 200 can act, in various embodiments, as an inquiring device.

In an example implementation, as illustrated in FIG. 3, as car 320 proceeds along the road, blue1 302 and blue2 304 are performing a paging operation while the OBE in car 320 is performing a page scan. For simplicity of description, the operations of an OBE 100 in car 320 may be referenced below as the operations of car 320 itself.

Car 320 responds to the page messages or inquiry messages from blue1 302 by sending a response that includes its unique identifier (ID). The unique ID is registered by the Bluetooth interface blue1 and relayed to centralized control system 306. Control system 306 can be, for example, one or more server data processing systems having processors, memories, and storage, and is configured to perform actions as described herein. Control system 306 is an example of means for analyzing data produced by the RSE devices, and also as means for controlling the transmit power of the RSE devices.

As car 320 gets closer to the next intersection, Intersection B, Car 320 responds to the page messages or inquiry messages from blue2 304 by sending a response that includes its unique ID. The unique ID is registered by the Bluetooth interface blue2 304 and relayed to centralized control system 306.

Control system 306 can then analyze the collected information from all the blue1 302, blue2 304, and other connected RSEs in order to compute traffic related statistics such as the average travel time from Intersection A to Intersection B. Control system 306 may also use this information to control traffic signals 330 and 332.

Traffic data collection system such as those described herein require distinctive information about the cars from the individual OBEs in order to reach healthy decisions. For instance, if the wireless ranges of the RSEs largely overlap, then most of the vehicles will be identified by multiple interfaces at the same time. By having the OBE of car 320 simultaneously registered to multiple RSE, the estimation of travel time might become less reliable and such data might not be usable as it might be identified as faulty.

Disclosed embodiments minimize the overlapped regions of the RSEs. Through feedback from the control system 306, each RSE 200 readjusts its wireless transmit power in order to reduce the overlapping ranges and improve reliability of the data.

Reducing the transmission power reduces the range of the scan/inquiry packets that are sent, which consecutively reduces the transmission frequency of scan responses. Hence, when the scan power level is lowered, the wireless devices respond to the scan requests only if they are closer to the Bluetooth interfaces when compared with higher power scans. Thus, reducing the transmission power for the Bluetooth interfaces has the potential of better accuracy. However, there is a clear tradeoff that if the transmission power is lowered too much, the system might not function well since the transmission range will suffer.

The control system 306 can continuously collect information about the devices nearby, together with the time of discovery for each device recognized. This information, then, is used by the control system 306 in order to detect the devices that are discovered at multiple intersections at very close time instances. Using this information, the control system 306 identifies the intersections which have largely overlapping wireless ranges, and sends feedback messages to these wireless interfaces.

The control system 306 might decide to reduce the power level of an RSE if it has several common readings with another interface. Similarly, it might ask the interface to increase its power level if the number of readings from this intersection is very low (suggesting extremely small wireless range) and the number of common readings with other intersections is at a minimal level. The system can identify such issues and adjust the power of each RSE at each intersection independently.

Disclosed embodiments can manage the wireless ranges of the RSEs located at the traffic intersections via power level management in order to increase the reliability of the collected data. In particular, the system can dynamically adjust the transmit power of the transceivers of each RSE in order to ensure that the transmission area of the inquiry or paging messages is large enough to obtain the desired responses from OBEs, but is not so large as to cause a problem by excessive overlap with the transmission area of other RSEs.

Preferably, Bluetooth®-compliant RSEs support Variable Inquiry TX Power Level and are capable of setting the transmission (TX) power level for inquiry processes. TX Power Level can be represented as a 1-byte 0xXX value that represents a transmission power level in the range −127 to +127 dBm. Each RSE can support a Read Inquiry Response Transmit Power Level Command that reads the inquiry response Transmit Power level used to transmit the FHS and EIR data packets. This can be used directly in the Tx Power Level EIR data type. Each RSE can support a Write Inquiry Transmit Power Level Command that writes the transmit power level used to transmit the inquiry (ID) data packets.

The control system 306 can maintain, in memory or other storage, data related to the OBEs detected by the RSEs at any given time. The table below is a non-limiting example of such data. The “Device” column represents the unique ID for an OBE device, and the other columns indicate the time at which that device ID was detected by each RSE, for example by receiving a response to a paging or inquiry message sent by the respective OBE.

| | blue1 | blue2 |
|---|---|---|
| Device | (time) | (time) |
| AA:BB:CC:DD:EE:FF | (12:42:25) | — |
| AA:BB:CC:DD:EE:FF | (12:42:45) | — |
| AA:BB:CC:DD:EE:FF | (12:43:05) | (12:43:05) |
| AA:BB:CC:DD:EE:FF | (12:43:25) | (12:43:25) |
| AA:BB:CC:DD:EE:FF | (12:43:45) | (12:43:45) |
| AA:BB:CC:DD:EE:FF | (12:44:05) | (12:44:05) |
| AA:BB:CC:DD:EE:FF | — | (12:44:25) |

Note that in this example, the device AA:BB:CC:DD:EE:FF was detected by both RSEs for a period of approximately one minute as the device traveled over the road between them. The system can determine from the accumulated data that the transmit power of one or both RSEs should be adjusted. Typically, after adjustment, the system will analyze similar date from another OBE device to determine whether the “overlap” situation has improved. Of course, other information could be recorded and tracked, but this table serves to illustrate a range overlap between blue1 and blue2.

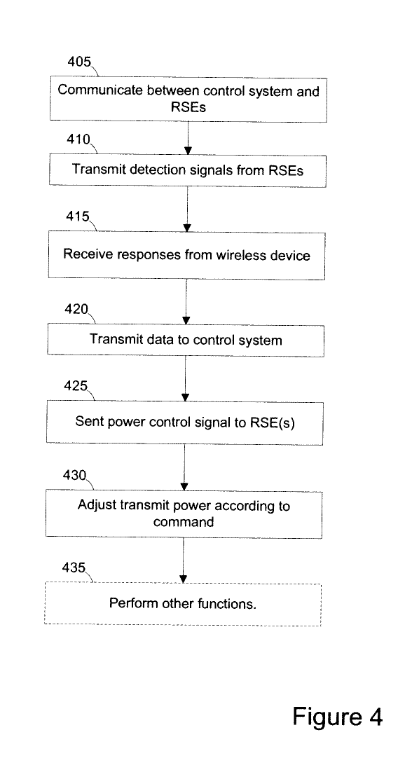

FIG. 4 depicts a flowchart of a process in accordance with disclosed embodiments. The RSE steps described below can be performed by processor 204, in various embodiments. As used herein, the “system” will refer to the operations of control system 306 and one or more RSE devices 200 as a combined traffic monitoring system.

A control system communicates with a first RSE and a second RSE (step 405). The RSEs are geographically separated from each other, and each includes a transceiver with a adjustable transmission power. The RSEs can each be located at an intersection or other location proximate to a roadway. While this particular example only describes two RSEs, the processes and systems described herein can include multiple RSEs, and can perform the power-adjustment techniques with respect to any of them.

The first RSE and the second RSE transmit wireless signals to detect a wireless device (step 410). These signals can be, for example, Bluetooth®-compliant paging or inquiry messages, and the wireless device can be an OBE device, including a Bluetooth®-compliant device in a vehicle. The RSE devices and the wireless devices are configured for Bluetooth®-compliant communications which can include but is not limited to this specific messaging.

The first RSE and the second RSE receive responses from the wireless device (step 415). Each response includes a unique identifier corresponding to the wireless device. The responses can be received at the same (or approximately same) time, or at different times.

The first RSE and the second RSE transmit data to the control system (step 420). The data can include the unique identifier and the time(s) at which the first and second RSEs received the responses.

Based on the received data, the control system sends a power control command to one or both of the RSEs (step 425). The command is received by one or both of the RSEs. The command can be, for example, a Bluetooth-compliant Write Inquiry Transmit Power Level Command.

The power control command can be a command to increase transmit power, for example if there is no (or not enough) “overlap” in the times that the responses are received by the first and second RSE. The power control command can alternately be a command to decrease transmit power, for example, if there is “overlap” (or too much overlap) in the times that the responses are received by the first and second RSE.

One or both of the RSEs adjusts its transmit power according to the power control command (step 430). Using the power control command, the control system effectively adjusts the transmit power of the RSE device(s) based on the data, and can do this to ensure that only one RSE device receives responses from the wireless device at a time or that responses are not received by multiple RSE devices for any given length of time.

The control system can also perform other functions based on the data (step 435), including calculating road speeds, controlling traffic signals or other devices, receiving and analyzing additional data for a different wireless device, and otherwise.

The process above can be performed repeatedly and simultaneously for a plurality of wireless devices and a plurality of RSEs, to constantly receive and analyze data regarding the travel of vehicles past and between RSEs, and to dynamically adjust the transmit power of the RSEs to ensure accurate data collection.

Disclosed embodiments provide distinct technical advantages in traffic control and monitoring as described herein, for example by providing more accurate tracking of vehicles using wireless signals.

Other traffic control systems are described in Bakker, B.; Whiteson, S.; Kester, L.; Groen, F. C. A. “Traffic light control by multiagent reinforcement learning systems”, Interactive collaborative information systems, Vol. 281, p. 475-510, hereby incorporated by reference.

Those skilled in the art will recognize that, for simplicity and clarity, the full structure and operation of all systems suitable for use with the present disclosure is not being depicted or described herein. Instead, only so much of an OBE and an RSE system as is unique to the present disclosure or necessary for an understanding of the present disclosure is depicted and described. The remainder of the construction and operation of the systems disclosed herein may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form. None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

What is claimed is:

1. A method, comprising:
transmitting wireless signals from a first roadside equipment (RSE) device and from a second RSE device that is geographically separated from the first RSE device;
receiving responses by the first RSE device and second RSE device from a wireless device, the responses including a unique identifier corresponding to the wireless device;
transmitting data from the first RSE device and the second RSE device to a control system, the data including the unique identifier and times that the responses were received;
receiving a power control command from the control system by the first RSE device, the power control command based on the transmitted data; and
adjusting a transmit power of the wireless signals transmitted by the first RSE device based on the power control command.

2. The method of claim 1, wherein wireless signals and responses are Bluetooth®-compliant.

3. The method of claim 1, wherein the transmitted data indicates that the responses were received at approximately the same time, corresponding to the same unique identifier, by both the first RSE and the second RSE.

4. The method of claim 3, wherein the power control command is a command to reduce transmit power by the first RSE.

5. The method of claim 1, wherein the power control command is a command to increase transmit power by the first RSE.

6. A method, comprising:
providing data communications between a control system and a plurality of roadside equipment (RSE) devices, including at least a first RSE device and a second RSE device, the RSE devices geographically separated from each other and from the control system;
receiving data from the first RSE device and the second RSE device by the control system, the data including a unique identifier for a wireless device in a vehicle and times that responses were received from the wireless device by the first RSE device and the second RSE device; and
sending a power control command, based on the received data, from the control system to the first RSE device, the power control command instructing the first RSE device to adjust a transmit power accordingly.

7. The method of claim 6, wherein the RSE devices and the wireless devices are configured for Bluetooth®-compliant communications.

8. The method of claim 6, wherein the received data indicates that the responses were received at approximately the same time, corresponding to the same unique identifier, by both the first RSE and the second RSE.

9. The method of claim 8, wherein the power control command is a command to reduce the transmit power by the first RSE.

10. The method of claim 6, wherein the power control command is a command to increase the transmit power by the first RSE.

11. A traffic monitoring system, comprising:
a control system; and
a roadside equipment (RSE) device located geographically separate from the control system, comprising at least a processor and a wireless transceiver, the RSE device configured to transmit wireless signals and receive corresponding responses from a wireless device, and to send data to the control system corresponding to the responses and times the responses were received,
wherein the control system adjusts the transmit power of the RSE device based on the data.

12. The traffic monitoring system of claim 11, wherein the data indicates that the responses are received by the first RSE device at approximately the same time as responses are also received from the wireless device by a second RSE device.

13. The traffic monitoring system of claim 11, wherein the RSE device and the wireless device are configured for Bluetooth®-compliant communications.

14. The traffic monitoring system of claim 11, wherein the transmitted wireless signals are Bluetooth®-compliant inquiry messages.

15. The traffic monitoring system of claim 11, wherein the transmitted wireless signals are Bluetooth®-compliant paging messages

16. The traffic monitoring system of claim 11, wherein the traffic monitoring system includes a plurality of RSE devices, and the control system adjusts the transmit power of individual RSE devices to ensure that only one RSE device receives responses from the wireless device at a time.

18. A traffic monitoring system, comprising:
detecting means for detecting wireless devices traveling on a roadway, the detecting means including a transceiver;
analyzing means for analyzing data produced by the detecting means; and
power control means for controlling a transmit power of the transceiver.

19. The traffic monitoring system of claim 18, wherein the detecting means includes multiple geographically-separated roadside equipment devices each including a transceiver and configured to detect the wireless devices as they travel between the roadside equipment devices.

20. The traffic monitoring system of claim 18, wherein transmit power of the transceiver is controlled based on the data analysis.
